(19) United States
(12) Patent Application Publication
(10) Pub. No.: US 2012/0041773 A1
(43) Pub. Date: Feb. 16, 2012

(54) COMPUTERIZED SYSTEM FOR ADAPTIVE RADIATION THERAPY

(76) Inventors: Patrik Kunz, Baden (CH); Michael Huber, AG (CH)

(21) Appl. No.: 12/855,126

(22) Filed: Aug. 12, 2010

(51) Int. Cl. G06Q 50/00

(52) U.S. Cl. 705/2

(57) ABSTRACT

In one embodiment of the invention, a computerized method for producing a treatment decision for adaptive radiation therapy (ART) is disclosed. The method comprises several steps. First, patient specific input data regarding a patient and general patient population data are input into a treatment decision engine. Next, this data is analyzed in order to adjust a set of interrelationships and thresholds to fit the ART regimen for which a decision is being processed. In a third step, the interrelationships and thresholds are applied to the data using a processing module which formulates a decision regarding the current ART regimen, and metadata regarding the medical condition of the patient. Finally, the decision and metadata are outputted such that they are accessible to a user. Using such a method, a treatment decision for ART is produced.

### FIELD OF THE INVENTION

The invention relates generally to medical diagnostic and treatment technology, and more specifically to adaptive radiation therapy.

### BACKGROUND OF THE INVENTION

Cancer has been known to humankind for over three thousand years, yet a guaranteed cure continues to elude the capabilities of modern technology. The past century has seen tremendous advances in humankind's arsenal of weapons to be used against the disease. Radiation treatment has in particular been the subject of continual improvement. Although applications of radiation were used to treat cancer at the turn of the 20^{th} century, modern approaches to radiation therapy are exponentially more advanced. The introduction of technologies such as Varian Medical Systems' RapidArc™ radiotherapy technology, 3-D conformal therapy, SmartBeam™ IMRT, and DynamicTargeting® IGRT technology have lead to astonishing improvements in survivability rates and overall patient comfort throughout the course of a radiation therapy treatment plan. However, despite heroic efforts on the part of physicians, scientists, and researchers throughout the world, cancer is still one of the leading causes of death in the United States. The American Cancer Society estimates that 562,340 deaths in the United States during 2009 were caused by cancer. Therefore, continual advances in the performance of cancer treatments are of the utmost importance for the health of the people of the United States and the world.

Current approaches for the treatment of cancer include chemotherapy, radiation therapy, surgery, immunotherapy, monoclonal antibody therapy, and other approaches. Regardless of the method chosen, the ultimate goal of the treatment is the removal of cancer from a patient's body, and the prevention of harm to a patient's healthy tissue. Since cancer comes in many forms, it is unlikely that a single one of these treatments will ultimately “win” as the best cure for cancer. Instead, each is important, and advances in any form of cancer treatment will continue to complement a therapist's arsenal against the disease now and in the future.

Radiation therapy is the use of ionizing radiation to kill cancer cells. Radiation is given through beam radiotherapy or internally through brachytherapy. One of the main benefits of radiation is that, similar to surgery, the radiation can be highly focused on a particular portion of the patient, thereby mitigating harm to the rest of a patient's body. Radiation attacks the genetic material of a cell. As such, when cells are divided and their double helix is unwound, they are more susceptible to radiation. Since cancer cells tend to divide and grow faster than regular healthy tissue, they are more susceptible to this form of damage. However, healthy cells are unavoidably damaged as well. Therefore, radiation therapy is applied in many periodic sessions with the hope that the healthy tissue will be able to heal itself in-between doses.

Online adaptive radiation therapy (ART) is a special form of radiation therapy that seeks to apply the optimal amount of radiation based on monitoring the tumor's reaction to previous applications of radiation. ART techniques adapt the treatment on a periodic basis in response to detected changes in both patient position and the shape of the tumor, as well as many other data inputs. These techniques usually use image-guidance systems to detect changes in the patient setup, and changes in the shape of the tumor or the organs at risk. The decision for whether an adaptation of the treatment plan or the treatment position is necessary is currently a fully manual process based on the subjective judgment of a treatment administrator. The administrator will analyze images of the tumor obtained through the use of medical diagnostic equipment, and will then make a decision based on their own knowledge, experience, and intuition.

### SUMMARY OF INVENTION

In one embodiment of the invention, a computerized method for producing a treatment decision for adaptive radiation therapy (ART) is disclosed. The method comprises several steps. In a first step, patient specific input data regarding a patient and general patient population data are inputted into a treatment decision engine. In a second step, a set of interrelationships and thresholds that apply to the patient specific input data and general patient population data are adjusted to fit an adaptive radiation therapy regimen under analysis. In a third step, the interrelationships and thresholds are applied to the patient specific input data and general patient population data with a processing module which formulates a decision regarding the current ART regimen and metadata regarding a medical condition of the patient. In a fourth step, the decision and metadata are outputted such that they are accessible to a user. Using such a method, a treatment decision for ART is produced.

### BRIEF DESCRIPTION OF THE DRAWINGS

FIG. 1 illustrates a block diagram of a decision engine that is in accordance with the present invention.

FIG. 2 illustrates a block diagram of a decision engine with a data network connection that is in accordance with the present invention.

FIG. 3 illustrates a flow chart of a method for producing a treatment decision for ART that is in accordance with the present invention.

FIG. 4 illustrates a flow chart of another method for producing a treatment decision for ART that is in accordance with the present invention.

FIG. 5 illustrates a block diagram of a system that is in accordance with the present invention.

### DETAILED DESCRIPTION OF THE PREFERRED EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers such modifications and variations as come within the scope of the appended claims and their equivalents.

Current approaches to ART have several drawbacks. At present, the ART decision process is time consuming, sometimes inaccurate, and is based on a subjective decision making process based on intuition that can be susceptible to failure. In addition, modern ART generally requires expensive image-guidance systems for detecting the relative position of a patient. This limits the application of ART to a specialized medical examination room, and generally increases the cost of treatment. The present invention addresses all of these drawbacks.

The current approach to ART can produce erroneous decisions, and is highly time consuming. In order for a treatment administrator to have the data available to make an informed opinion, a multitude of highly detailed scans of a patient are necessary. Analysis of the current progress of a patient's regimen involves an enormous amount of data and the appreciation of a multitude of minor difference between different data points. Although human intuition is a powerful force for pattern recognition and decision making, the human mind can be overwhelmed by a deluge of data and the human eye may miss small but critical changes in the scanned images of a patient's body. Even if a proper decision is finally reached, the careful study of minor differences between a barrage of hazy images is extremely time consuming.

Since the current approach is so time consuming, current approaches to ART suffer the derivative problem of therapy not being adapted as often as is desirable. A pure adaptive therapy procedure would involve near constant monitoring and adaptation of the administered radiation dosage. Since the current judgment process is so subjective and difficult, it is rarely conducted on a daily basis. A treatment administrator's time is generally extremely expensive and cannot be spent constantly monitoring the tumor. Therefore, the current process has the potential to miss critical changes in the patient's medical conditions that should have triggered a change in the applied regimen.

The current approach address all of the discussed drawbacks faced by the prior art. The present invention provides an automated decision support system for ART. Since the decision process is automated, the torrent of data regarding the patient's condition is channeled and weighted with far greater ease than it is in the case of subjective heuristic analysis. For example, patient position can be treated as another input to the decision engine and can be filtered out of the decision process automatically so that it's not confused with tumor movement or shrinkage. In addition, the automation of the process significantly reduces the time necessary for measurements to be taken and for the decision to be produced. Since the time necessary for analysis has shrunk to near zero, the analysis can be run while the patient is on the treatment table. Also, since the bulk of the decision process's cost has shifted from the high variable cost of a treatment administrator's time to the fixed cost of producing the decision engine, the cost of an additional monitoring actually decreases with each application. With increasing advances in medical monitoring and diagnostic equipment, the present invention could enable pure continual ART through constant monitoring of the patient's condition.

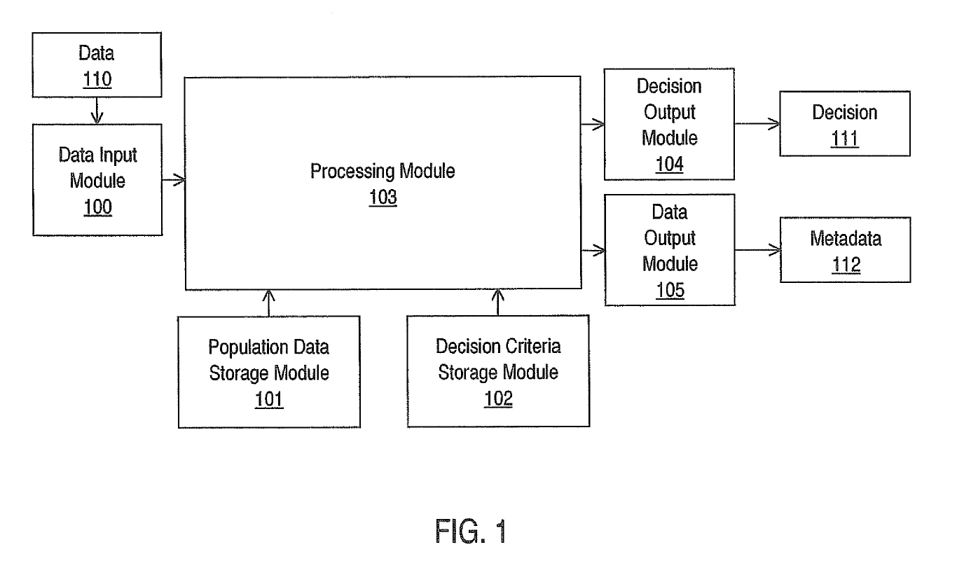

A treatment decision engine for use in adaptive radiation therapy that is consistent with the present invention can be understood with reference to FIG. 1. The treatment decision engine in FIG. 1 is comprised of several modules. Describing the individual components as modules does not preclude the implementation of the entire system as a unitary whole. The modules are described as such to facilitate an understanding of the invention by breaking it up into functional components. Input data module 100 receives patient specific input data 110 and stores it for later processing. Patient population data storage module 101 contains general patient population data which it can deliver to processing module 103. Decision criteria storage module 102 stores a set of interrelationships and thresholds. These decision criteria either apply to patient specific input data 100 alone or compare patient specific input data 100 to the general patient population data. Processing module 103 handles the application of the set of interrelationships and thresholds to the data that it receives, and delivers a decision regarding the ART regimen under analysis to a clinical decision output module 104, and a set of metadata to data output module 105.

Input data module 100 could be implemented using a variety of input methods and devices. Input data could be received manually from a user of the decision engine. Note that the term “user” in this situation and in the remainder of this application could possible refer to the treatment administrator, but the term is more broad and refers to any person that may be using the decision engine. Input data could also be received automatically from a medical diagnostic tool such as a scanner or an augmented personal data assistant. Input data could also be input through the use of remote monitoring equipment.

Patient specific input data 110 includes information regarding the response of tumors and healthy tissues in the patient's body to the past administration of radiation. As such, a bulk of the data will be diagnostic electronic images of the patient's internal organs. These images will likely focus on the areas of the patient's body that are afflicted with cancer. The images could be produced through the use of Cone Beam Computerized Tomography (CBCT), Computerized Tomography (CT), Magnetic Resonance Imaging (MR), Positron Emission Tomography (PET), Single Positron Emission Computerized Tomography (SPECT), or ultrasound. Patient specific input data 110 could also include planning structures of several images used to determine what is a tumor and what is not.

Patient specific information could include a large body of additional clinically relevant information. For example, information on tumor motion and size, the dose administered to the patient, the patient's demographic information, and the patient's vital statistics such as the patient's weight, temperature, and blood pressure could be included. Tumor motion and size can collectively be referred to as tumor dynamic. Tumor motion could be measured from a fixed point of reference and be provided as a vector value. Information on the planned and applied distribution of dose would be relevant for assuring that healthy tissue was not over exposed to radiation, and could provide an estimate of how resilient the tumorous cells were to radiation. Demographic information collected could include the age and ethnicity of the patient.

All of this data would advantageously be stored as a chronological matrix with time as the independent variable, meaning that each data value taken could be examined across the entire analysis and treatment period. This would facilitate the necessary comparison of the patient's progress and the cancer's tendency towards remission. For example, a chronological array of patient specific input data in the form of a group of CBCT images of a tumor on a patient's spine could show the tumor from the first day that treatment began all the way through to the present treatment application.

All of the patient specific input data could be stored by input data module 100 so that the next time the analysis procedure was run on a patient, their past data would be available for the decision engine. Contrarily, this data could be stored externally and be provided to input data module 100 anew every time the procedure was run on a patient. In addition, this information would not need to be stored in a format that was necessary for human visualization. The information could be digitized and compressed to only contain the information used by processing module 103. Although the list of specific patient information is extensive, the benefits of the invention related to a machine's ability to store and evaluate large amounts of data are such that the more data available to the system the better.

The general patient population information stored by patient population data storage module 101 would in large part mirror the patient specific information. This is because certain embodiments of the invention use the experiences of the general population as an analogy for determining the best course of action for a specific patient. Being able to match the situation of a specific patient to those in the general population requires data categories whose values can be compared. For example, the patient's age would appear in both data sets because patients of the same age may have similar responses to certain treatment regimens. Therefore, in specific embodiments of the invention, the general patient population information will mirror specific patient information for purposes of comparison under the interrelationships stored in decision criteria storage module 102.

Given the advantages in data analysis that accrue from using a computerized system, the general patient population data will in some embodiments include information on as many patients as may be available. However, in specific embodiments of the present invention the general patient population data will only consist of data relating to a single person or a small group of people sharing a specific characteristic. Moreover, even in embodiments where a larger patient population is used or available, the general patient population data of the present invention may consist of a subset of such data or specialized data, such as patient data relating to a specific disease site. In specific embodiments of the invention, the general patient population data will also comprise prior data taken regarding the same patient that is currently undergoing treatment.

Patient population data storage module 101 will also contain information necessary for the thresholds of decision criteria storage module 102 to apply. Data such as average weight loss in a relevant segment of the population, average tumor shrinkage, and average tumor dynamic could set threshold values for when a radiation therapy regimen should be adjusted. Also relevant would be data such as organ specific radio-sensitivity. This data would be important because it could set threshold limits on the dose that could be applied near certain organs or be applied to weigh against a computed decision to apply a high dose of radiation to a sensitive portion of a patient's body.

In one embodiment of the invention, patient population data storage module 101 could be updated after it has gone into regular use. The module could contain an updatable library that could be modified on the fly. The library could be updated through physical delivery of storage medium containing the library updates. In addition, the module could be connected to a data network that could provide these updates instantly across the network. The basis for this information could be clinical research from entities that have practiced radiation therapy in the past, and updates could be provided as research uncovered new information regarding the response of different types of patients to different ART regimens.

Decision criteria storage module 102 stores interrelationships and thresholds that apply to the patient specific input data and general patient population data. In some embodiments of the invention, these thresholds will be predefined and will be populated in processing module 103 by information from said general patient population data based on the obtained patient specific input data from input module 100. For example, if processing module 103 receives patient specific input data that the patient is a ten-year-old male with a brain tumor, the threshold for maximum applied dose will be populated by the value for maximum allowable dose to a ten-year-old male's brain from the general patient population data.

The thresholds and interrelationships could include any intuitive basis for making a decision concerning the application of adaptive radiation therapy. Intuitive thresholds could be comprised of maximum allowable volume and position change for the organs of a patient and a maximum allowable dose for the organs of the patient. Intuitive interrelationships could be comprised of the progression of a particular tumor's remission as compared to other similar tumors under a similar regimen. In addition, certain thresholds and interrelationships could be discovered by the engine itself as discussed later.

In one embodiment of the invention, the thresholds and interrelationships in decision criteria storage module 102 could be programmed into the engine. In other embodiments of the present invention, they could be modified by a treatment administrator or updated. The module could provide infrastructure for a treatment administrator to tailor the module for their specialized application. Also, the module could contain an updatable library that could be modified as research uncovered new approaches to radiation therapy. The library could be updated through physical delivery of storage medium containing the library updates. In addition, the decision criteria storage module could be connected to a data network that could provide these updates instantly across the network. The basis for this information could be clinical research from entities that have practiced radiation therapy in the past and updates could be provided as research uncovered new information regarding relationships between a patient's condition and an applied radiation therapy regimen.

Processing module 103 applies the interrelationships and thresholds to said patient specific input data, and said general patient population data. In one embodiment of the invention, the processing module would be able to call a number of sub-modules for specific calculation tasks in order to generate the information required to produce the final clinical decision and metadata.

Clinical decision output module 104 outputs clinical decision 111 after processing module 103 has examined all of the relevant data. In one embodiment of the invention, clinical decision 111 would be a simple yes or no decision regarding whether it is recommended to perform an adaptation of the treatment plan. However, in other embodiments of the invention, clinical decision 111 would contain detailed information on how the treatment plan should proceed such as adjustment of the number of beams, beam geometry, motion management scheme, patient position, and overall dose. The motion management scheme refers to how the change in the tumor position will be handled through the course of the treatment as the tumor could slip away from where the radiation is being applied or move to a portion of the patient's body that is more sensitive to radiation.

Patient related output data module 105 outputs metadata 112 which regards the medical condition of the patient and the effect of the ART regimen on the patient. Any information relevant to the medical condition of the patient could potentially be included in output metadata 112. Of particular importance would be the diagnostic electronic images of the afflicted portions of the patient that were taken on the current and past applications. Also of relevance would be an image or representation of the present and cumulative application of radiation to the patient. An assortment of other data that could be included could be expressed in scalar or vector form such as differences in organ volumes, differences in organ center of mass position, differences in tumor volumes, differences in tumor center of mass position, and the presence of hotspots and their positioning. Data could also be output in matrix form such as a matrix of organ specific dose risk level or in the case of multiple tumors, a matrix of the prior noted information for each of the individual tumors.

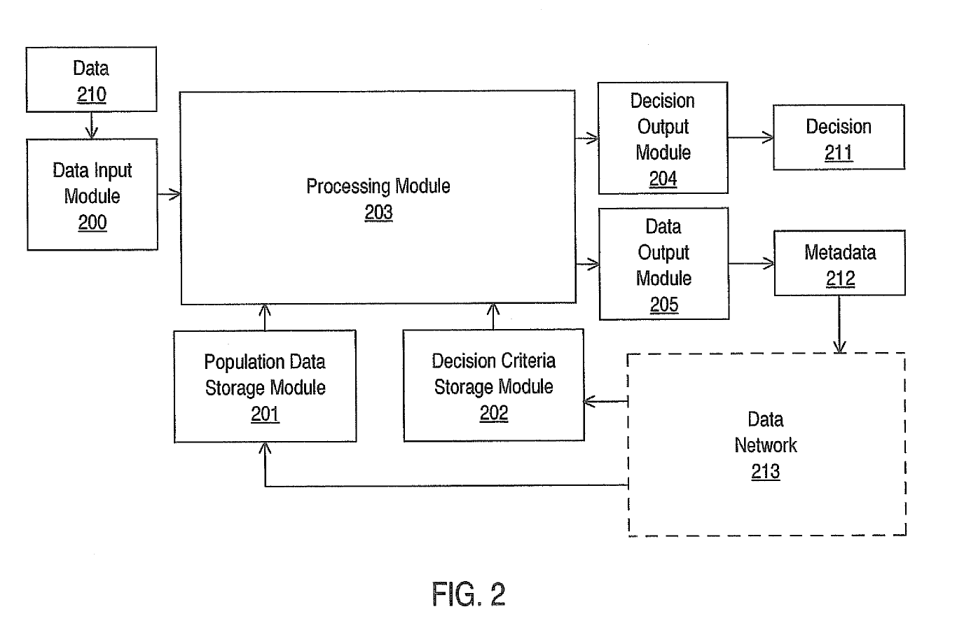

Another treatment decision engine for use in ART that is consistent with the present invention can be understood with reference to FIG. 2. The treatment decision engine for use in ART in FIG. 2 is mostly comprised of the same modules as the decision engine in FIG. 1. Patient specific input data 210, input data module 200, processing module 203, clinical decision output module 204, and clinical decision 211 all have the same characteristics as the corresponding portions of FIG. 1. The main difference between the decision engines in FIG. 1 and FIG. 2 is that data output module 205 outputs metadata 212 to data network 213.

The fact that metadata 212 is output to a data network creates the possibility for the decision engine to work with other similar decision engines to constantly improve their performance. The metadata that is output to data network 213 can be used to improve the performance of the decision engine by updating the general patient population data in patient population storage module 201, and the interrelationships and thresholds in decision criteria storage module 202.

In specific embodiments of the invention, the general patient population data is comprised mainly of a set of data regarding the condition of a patient and the change in that condition given a specified application of ART. Metadata 212 will contain information regarding a specific patient's condition and the change in that condition given the previously recommended treatment. Therefore, metadata 212 will contain the exact information stored in the general patient population data for a specific patient and can be used to increase the depth of the database. This will improve the performance of the engine because the greater number of patients that there is data for, the more likely a future patient will be suffering from an analogous condition thereby allowing the decision engine to recommend a previously successful radiation regimen.

The interrelationships and thresholds can also be updated through use of the metadata. As mentioned previously, in some embodiments of the invention these rules are based on prior clinical research. Each application of the decision engine to a particular patient can be thought of as another clinical test because the effect of a treatment decision is examined when the patient's condition is measured on the next iteration of the treatment. Therefore, each additional set of metadata contains information regarding the performance of another clinical trial which is exactly the type of data that the decision criteria module requires.

Also mentioned previously is the possibility that the metadata may be used to uncover non-intuitive interrelationships among the data. If neural network architecture is built into data network 213, it is possible that new relationships will be found between the selected regimen and that regimen's ability to force cancer into remission. For example, it may be found that doses that were applied to the center of tumors of the lung caused faster reduction in tumor size than doses targeted elsewhere. Although a clinician would not be able to detect this trend because they do not have all of the examples in front of them, a neural network would have all of the examples at it's disposal and would automatically shift treatment regimen suggestions towards the center of the tumor if a patient was suffering from lung cancer.

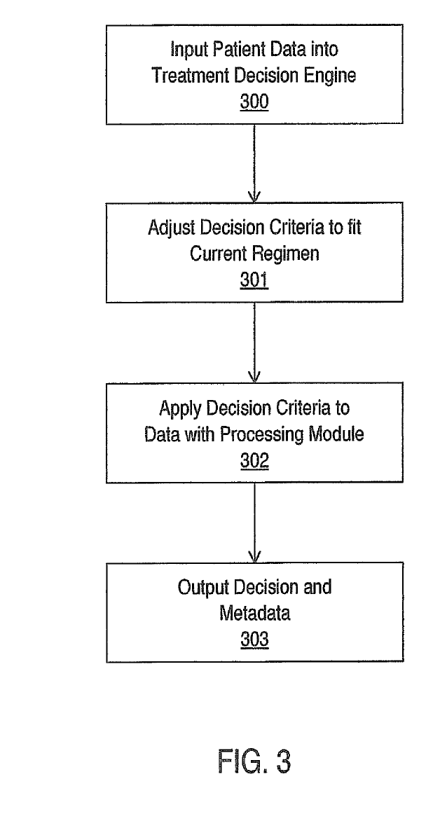

A computerized method for producing a treatment decision for ART that is consistent with the present invention can be understood with reference to FIG. 3. In step 300, patient specific input data regarding a patient, and general patient population data are input into a treatment decision engine. The patient specific data and general patient population data used in this step are as described above in reference to FIGS. 1 and 2. In step 301, a set of interrelationships and thresholds that apply to the abovementioned data are adjusted to fit the radiation therapy regimen under analysis. As discussed above with reference to FIGS. 1 and 2, the relevant thresholds and interrelationships will be chosen based on the patient specific input data, and will be populated with values based on the patient specific data and general patient population data. In step 302, the interrelationships and thresholds as modified will be applied to the patient specific input data and general patient population data with a processing module. The result of this application will be the formulation of a decision regarding the current ART regimen, and metadata regarding a medical condition of the patient. In step 303, the metadata and decision will be output such that a user of the method may access them. The metadata and decision output to the user in this step are as described above in reference to FIGS. 1 and 2.

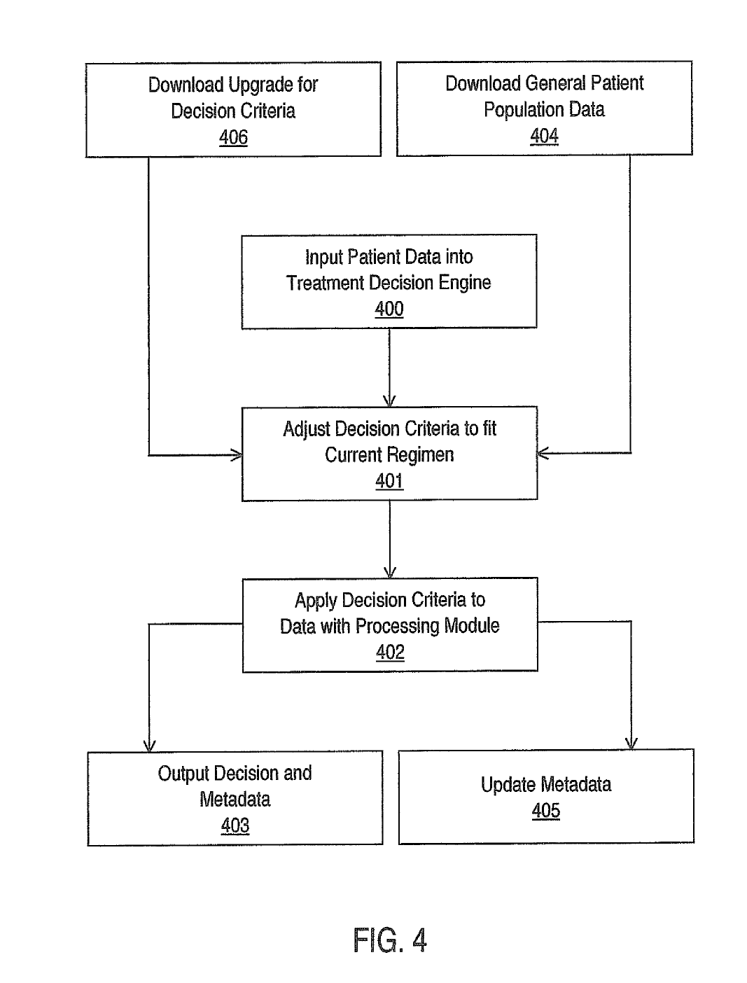

Another computerized method for producing a treatment decision for adaptive ART that is consistent with the present invention can be understood with reference to FIG. 4. The computerized method shown in FIG. 4 is similar to the method in FIG. 3 in that the method in FIG. 4 contains the same steps of inputting 400, adjusting 401, applying 402, and outputting 403 as in FIG. 3. However, the addition of downloading step 404, uploading step 405, and upgrading step 406 drastically distinguish the capabilities of this method.

In step 405, the metadata produced in step 403 is uploaded to a data network. As discussed above, this data can be considered both another portion of data for said general patient population data, and the basis for the alteration of said interrelationships and thresholds to which all of the data is applied in step 402. Each application of the method will provide another set of relationships between a patient's condition and the effect of a specific ART regimen on such condition. Therefore, without any modifications besides possible deletions of irrelevant data, this metadata can comprise a portion of the general patient population data and can be downloaded in step 404. This data will combine with the data input in step 400 and the collective body of information produce will be applied to the adjusting step 401. In addition, after a certain degree of processing the metadata may be used to alter the interrelationships and thresholds that would be relevant for conditions similar to the ones in which the metadata was obtained. Therefore, in step 406 upgrades for the interrelationships and thresholds that are applied in step 401 can be downloaded from the data network.

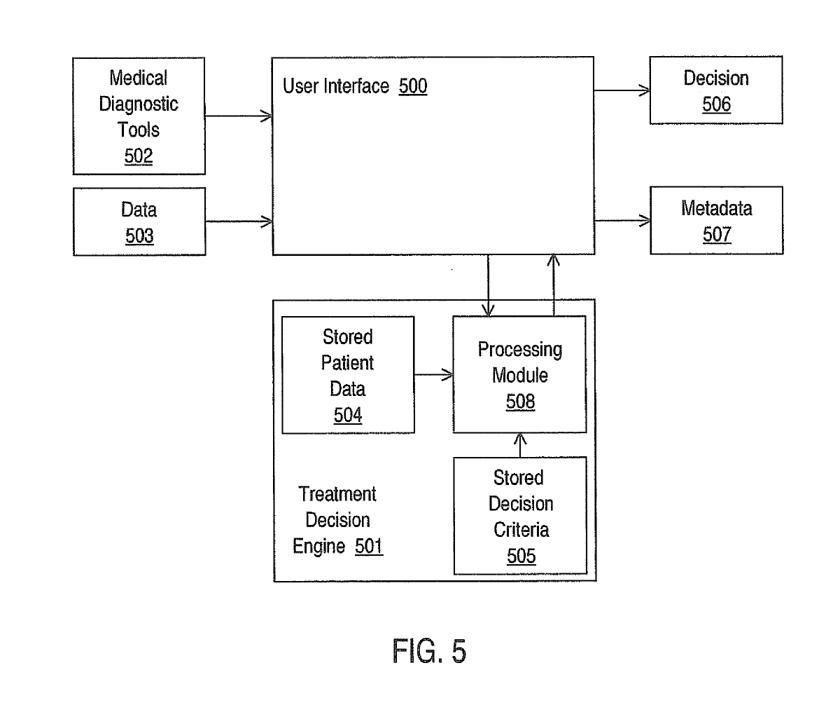

A system for providing a treatment decision for a patient undergoing ART that is consistent with the present invention can be understood with reference to FIG. 5. The system in FIG. 5 is comprised of a user interface 500, a treatment decision engine 501, and medical diagnostic tools 502. User interface 500 can take in patient specific input data from medical diagnostic tools 502, and it can also take in other patient specific input data 503 through other means such as a keyboard or an augmented personal data assistant. Treatment decision engine 501 contains stored general patient population data 504 and a stored set of interrelationships and thresholds 505. Treatment decision engine 501 is mainly comprised of processing module 508. Processing module 508 applies the patient specific input data from user interface 500 and the stored general patient population data 504 to said interrelationships and thresholds 505 to produce a decision and metadata. User interface 500 outputs decision 506 and metadata 507 after they are provided by treatment decision engine 501.

In one embodiment of the present invention, user interface 500 is capable of uploading the metadata to a data network and data 503 further comprises a set of updates from that data network. The updates would comprise a set of additional general patient population data that could be sent to treatment decision engine 501 and stored along with stored general patient population data 504. The updates could also comprise modifications for interrelationships and thresholds 505.

Although embodiments of the invention have been discussed primarily with respect to specific embodiments thereof, other variations are possible. Various configurations of the described system may be used in place of, or in addition to, the configurations presented herein. For example, although the decision engine was discussed as if it was being implemented using a custom designed machine, it could also be implemented using a general purpose computer. The invention is not limited to use in a hospital or treatment center, but instead could be applied anywhere a patient was present. Nothing in the disclosure should indicate that the invention is limited to a certain number of applications or treatments within a given time span as it may be implemented periodically or continuously. Functions may be performed by hardware or software, as desired. In general, any diagrams presented are only intended to indicate one possible configuration, and many variations are possible. Those skilled in the art will also appreciate that methods and systems consistent with the present invention are suitable for use in a wide range of applications encompassing any form of adaptive therapy. While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims. Furthermore, those skilled in the art will appreciate that the foregoing description is by way of example only, and is not intended to limit the invention.

What is claimed is:

1. A treatment decision engine for use in adaptive radiation therapy comprising:
an input data module that receives patient specific input data regarding a patient;
a patient population data storage module that stores general patient population data;
a decision criteria storage module that stores interrelationships and thresholds that apply to said patient specific input data and said general patient population data;
a processing module that applies said interrelationships and thresholds to said patient specific input data and said general patient population data;
a clinical decision output module that outputs a decision regarding an adaptive radiation therapy regimen for said patient;
wherein said general patient population data comprises clinically relevant information.

2. The treatment decision engine from claim 1, wherein said input data module receives data automatically from a medical diagnostic tool.

3. The treatment decision engine from claim 1, wherein said input data module receives data manually from a user.

4. The treatment decision engine from claim 1, wherein said input data module downloads data from a remote monitoring device.

5. The treatment decision engine from claim 1, wherein said interrelationships and thresholds can be modified manually by a user.

6. The treatment decision engine from claim 1, wherein:
said patient population data storage module can be updated through a connection to a first data network; and
said decision criteria storage module can be updated through a connection to a second data network.

7. The treatment decision engine from claim 1, wherein said general patient population data is comprised of:
a measure of average tumor variation in response to variant treatment regimens;
a time varying measure of patient weight change for variant treatment regimens;
a time varying measure of average tumor dynamic for variant treatment regimens; and
a measure of organ specific radio-sensitivity.

8. The treatment decision engine from claim 1, wherein said patient specific input data is comprised of:
a time varying series of diagnostic electronic images of the afflicted portions of said patient;
a time varying measure of a position of a tumor and at least one organ of said patient;
a time varying measure of a dose distribution and prior planned does distributions; and
a set of clinically relevant information for said patient.

9. The treatment decision engine from claim 1, wherein said interrelationships and thresholds are comprised of:
a maximum allowed volume change for the organs of said patient;
a maximum allowed position change of the organs of said patient;
a maximum allowed dose per application for each of said organs;
a maximum allowed overall treatment dose for each of said organs;
a maximum allowed dose difference between a dose applied to certain organs as compared to said maximum allowed dose; and
a comparison of a tumor of said patient with an average tumor size for said general population.

10. The treatment decision engine for use in adaptive radiation therapy from claim 1, wherein said decision is comprised of:
a determination of the necessity of a first alteration of the current course of treatment;
a determination of a required beam angle and beam geometry for said first alteration;
a determination of a required dose for said first alteration;
a determination of the necessity of a second alteration of the tumor motion management scheme;
a determination of the necessity of a third alteration in a patient position during administration of radiation; and
a determination of the necessity of an application of additional diagnostic procedures.

11. The treatment decision engine from claim 1, wherein said clinically relevant information comprises demographic information.

12. The treatment decision engine from claim 1, further comprising a patient related data output module that outputs metadata regarding a medical condition of said patient, and an effect of said adaptive radiation therapy regimen on said patient.

13. The treatment decision engine from claim 12, wherein said metadata is comprised of:
a group of diagnostic electronic images of the afflicted portions of said patient;
a group of images of the distribution of dose in a patient;
a measure of differences in organ volumes;
a measure of differences in organ center of mass position;
a measure of differences in tumor volumes;
a measure of differences in tumor center of mass position;
a measure of hotspot position
a time varying series of three dimensional images of the cumulative distribution of dose in a patient; and
a matrix of organ specific dose risk level.

14. The treatment decision engine from claim 12, wherein:
said metadata is selectively outputted to a data network; and
said patient population data storage module is updated through a connection to said data network.

15. The treatment decision engine from claim 12, wherein:
said metadata is selectively outputted to a data network; and
said decision criteria storage module is updated through a connection to said data network.

16. A computerized method for producing a treatment decision for adaptive radiation therapy, comprising the steps of:
inputting patient specific input data regarding a patient and general patient population data into a treatment decision engine;
adjusting a set of interrelationships and thresholds that apply to said patient specific input data and said general patient population data to fit a current adaptive radiation therapy regimen under analysis;
applying said interrelationships and thresholds to said patient specific input data and said general patient population data with a processing module to formulate a decision regarding said current adaptive radiation therapy regimen and metadata regarding a medical condition of said patient; and
outputting said decision and said metadata such that said decision and said metadata are accessible to a user.

17. The computerized method from claim 16, further comprising:
uploading said metadata to a data network; and
downloading an upgrade for said set of interrelationships and thresholds from said data network;
wherein said data network is constantly updated when said user implements said computerized method.

18. The computerized method from claim 16, further comprising:
uploading said metadata to a data network; and
downloading a portion of said general patient population data from said data network;
wherein said data network is constantly updated when said user implements said computerized method.

19. A system for providing a treatment decision for a patient undergoing adaptive radiation therapy, comprising:
a set of medical diagnostic tools measuring a first set of patient specific input data regarding a patient;
a user interface taking in said first set of patient specific input data and a second set of patient specific input data regarding said patient, and outputting a decision regarding an adaptive radiation therapy regimen for said patient and metadata regarding a medical condition of said patient; and
a treatment decision engine taking in said first set and said second set of patient specific input data, having a set of stored general patient population data, and applying said first, said second, and said general patient population data to a stored set of interrelationships and thresholds to produce said decision and said metadata;
wherein said general patient population data comprises clinically relevant information and demographic information for a general population of prior radiation therapy patients.

20. The system from claim 19, wherein said user interface allows a user to manipulate said stored set of interrelationships and thresholds to tailor said treatment decision engine for a subset of patients.

21. The system from claim 20, further comprising:
a data network uplink uploading said metadata to a data network;
a data network download connection downloading a set of updates from said data network;
wherein said updates include a set of additional general patient population data and a set of alterations for said interrelationships and thresholds; and
wherein said data network is constantly updated with said metadata when said treatment decision engine produces said metadata.
